(19) United States
(12) Patent Application Publication
(10) Pub. No.: US 2008/0033819 A1
(43) Pub. Date: Feb. 7, 2008

(54) Genomics based targeted advertising

(75) Inventor: Jacob Leschly, Redwood City, CA (US)

Correspondence Address: WILSON SONSINI GOODRICH & ROSATI, 650 PAGE MILL ROAD, PALO ALTO, CA, 94304-1050, US

(73) Assignee: INGENUITY SYSTEMS, INC., Mountain View, CA (US)

(21) Appl. No.: 11/829,784

(22) Filed: Jul. 27, 2007

Related U.S. Application Data
(60) Provisional application No. 60/820,773, filed on Jul. 28, 2006.

(51) Int. Cl. G06Q 30/00

(52) U.S. Cl. 705/14

(57) ABSTRACT

A method for targeted advertising comprising obtaining genomic data of an individual, correlating the genomic data to a personal trait of said individual and addressing advertising material to said individual based on said personal trait.

### FIELD OF THE INVENTION

This invention relates to methods for targeted advertising, in particular, utilizing an information database relating to biological data and more particularly genomics and other large-scale biology data for the purposes of understanding phenotypic traits and using those traits in targeted advertising.

### SUMMARY OF THE INVENTION

In one embodiment, the present invention provides a method for addressing targeted advertising material to a target audience comprising obtaining biological data of the target audience, correlating the biological data to a personal trait of the target audience and addressing advertising material to the target audience based on the personal trait.

In one embodiment, the invention provides a method wherein the biological information comprises information relating to one or more of a genome, individual genes, DNA sequences, mRNA, proteins and protein complexes that result when genes are expressed, drugs and metabolites they interact with, biochemical modifications, behavioral, environmental and social factors that influence the function of expressed proteins, and the biological, physiological and behavioral effects of the expressed proteins.

In one embodiment, the data comprise data extracted from multiple public sources.

In another embodiment, the data comprise data provided by users or their designated proxies.

In yet another embodiment, the data comprise data provided by health care providers.

In still another embodiment, the data comprise data obtained directly from a biological measurement technology such as a DNA sequencer or fingerprint machine.

In a further embodiment, the data comprises proprietary data.

In still another embodiment, the data is extracted from an individual's medical records.

In one embodiment, an individual in the audience is identified by an anonymous identifier.

In a further embodiment, the target audience is formed by one individual.

In another embodiment, the target audience is formed by one or more individuals that share one or more biological types.

In yet another embodiment, the data comprises data extracted from a combination of proprietary and public data sources.

In a further embodiment, the data comprises data extracted from a combination of proprietary and public data sources.

In one embodiment, the means for storing the genomics information includes an ontology in which:
(a) each gene, gene product, and biological effect is given an identifier which is related to synonyms for the identifier; and
(b) each gene, gene product, and biological effect is categorized by class.

In one embodiment, the trait related genomic data are prioritized based on factors that include function and complexity.

In another embodiment, the genomics information comprises information relating to genotype and the trait pathway comprises a gene or gene product associated with a particular genotype.

In still another embodiment, the targeted advertising is delivered through mail, electronic media, email, internet browsing, cell phone, wireless media.

In a further embodiment, the targeted advertising relates to a product for sport or leisure activity, investment opportunity, a car, a boat, a plane, health product or service, book or information service.

### DETAILED DESCRIPTION OF THE INVENTION

The last 5 years or so have seen an explosion in the availability of data relating to genomics, i.e., information related to genes, their nucleic acid sequences, the proteins these genes encode for, the drugs and metabolites they interact with, the biological effect of the proteins, and other related information. While the foregoing description illustrates one embodiment of the invention, wherein the data incorporated in advertising strategy is of a genomics nature, the invention contemplates the use of any type of biological data in tailoring targeted advertising strategies. Biological data useful in the context of the present invention include without limitation all biological data or measurements collected from biological sources, for example, stored or exchanged in a digital form. Biological data is commonly stored in files or databases. Examples of biological data are DNA base-pair sequences, genomic, proteomic and metabolomic data obtained from assayabale biological substances and population data used in ecology.

For example, the advent of large-scale, population genetic databases (PGDs) in several countries around the world marks a significant development in human DNA banking and genetic research. The European countries that have led the way in the development of PGDs are Iceland, Sweden, Estonia and the U.K. In one embodiment, the present invention provides a method for tailoring targeted advertising strategies based on data available in PGDs.

Other sources for useful biological data are provided in biological databases. Biological data bases have become an important tool in assisting scientists to understand and explain a host of biological phenomena from the structure of biomolecules and their interaction, to the whole metabolism of organisms and to understanding the evolution of species. This knowledge helps facilitate the fight against diseases, assists in the development of medications and in discovering basic relationships amongst species in the history of life. The present invention incorporates this type of biological information in tailoring targeted advertising strategies.

Available databases include a databases provided in a special (yearly) issue of the journal “Nucleic Acids Research” (NAR). The Database Issue is freely available, and categorizes all the publicly available online databases related to computational biology (or bioinformatics).

The invention contemplates incorporating data from primary sequence databases. Examples of primary sequence data bases include: DDBJ (DNA Data Bank of Japan), EMBL Nucleotide DB (European Molecular Biology Laboratory), GenBank, (National Center for Biotechnology Information.

Other sources of data include Genome Browsers. Genome Browsers enable researchers to visualize and browse entire genomes (most have many complete genomes) with annotated data including gene prediction and structure, proteins, expression, regulation, variation, comparative analysis, etc. Annotated data is usually from multiple diverse sources.

Other useful sources include Pathway Tools Genome Browsers including, without limitation, X:Map, a genome browser that shows Affymetrix Exon Microarray hit locations alongside the gene, transcript and exon data on a Google maps api.

Protein sequence databases contemplated in the present invention include, without limitations, UniProt, Universal Protein Resource (UniProt Consortium: EBI, Expasy, PIR), PIR Protein Information Resource (Georgetown University Medical Center (GUMC)), Swiss-Prot Protein Knowledgebase (Swiss Institute of Bioinformatics), PEDANT Protein Extraction, Description and ANalysis Tool (Forschungszentrum f. Umwelt & Gesundheit), PROSITE Database of Protein Families and Domains, DIP Database of Interacting Proteins (Univ. of California), Pfam Protein families database of alignments and HMMs (Sanger Institute), ProDom Comprehensive set of Protein Domain Families (INRA/ICNRS)

Other biological data suitable for incorporation in the design of advertising strategies according to the invention are obtained from pathway databases, including without limitation, BioCyc Database Collection including EcoCyc and MetaCyc, KEGG PATHWAY Database (Univ. of Kyoto), Reactome (Cold Spring Harbor Laboratory, EBI, Gene Ontology Consortium).

Other data is provided by Microarray-databases including, without limitation, ArrayExpress (European Bioinformatics Institute), Gene Expression Omnibus (National Center for Biotechnology Information), maxd (Univ. of Manchester), SMD (Stanford University), GPX(Scottish Centre for Genomic Technology and Informatics)

Other data is provides from specialized databases such as CGAP Cancer Genes (National Cancer Institute), Clone Registry Clone Collections (National Center for Biotechnology Information), DBGET H.sapiens (Univ. of Kyoto), GDB Hum. Genome Db (Human Genome Organisation), MGI Mouse Genome (Jackson Lab.), SHMPD The Singapore Human Mutation and Polymorphism Database, NCBI-UniGene (National Center for Biotechnology Information), OMIM Inherited Diseases (Online Mendelian Inheritance in Man), Off. Hum. Genome Db (HUGO Gene Nomenclature Committee), HGMD disease-causing mutations (HGMD Human Gene Mutation Database), List with SNP-Databases, p53 The p53 Knowledgebase, Edinburgh Mouse Atlas

The present invention relates to methods for identifying pathways for particular phenotypic traits and incorporating phenotypic information in directed or targeted advertising. In one embodiment, the invention makes use of a structured database representation of information concerning genes, gene products, processes, contextual influences and phenotypic traits of interest, and optionally other information (including for example information concerning DNA sequences, SNPs, non-genomic DNA sequences, allelic variations, etc.) in targeting advertising to a population of individuals having given phenotypic traits. Contextual influences can include biological, chemical, pharmaceutical, clinical, environmental, social, or general factors that can influence the state, behavior and function of pathways. The information that is stored typically comprises data from public sources such as databases and scientific publications. It can also be proprietary data or a mix of proprietary and public data. The phenotypic trait of interest is typically a personal preference trait.

The invention combines aspects obtained from the analysis of biological data, for example, determined by phenotypic trait and behavioral and/or environmental aspects (combination of nature and nurture factors). For example, targeted advertising can be directed to a subject having a particular phenotype and at the same having been exposed to environmental factors (e.g. where the subject lives) that is more likely to result in a different phenotype. For example, targeted advertising can be directed to subjects having SNP X and living near a particular location.

A fuller description of these embodiments of the invention, as well as other embodiments of the invention, which will become apparent from the following detailed description, follows. It is to be understood that both the foregoing general description and the following detailed description are exemplary and explanatory and are intended to provide further explanation without limiting the scope of the invention as claimed.

There are several uses for a structured database representation of genomics information. In one such use, a method for identifying a target includes the steps of querying the database to identify a trait-related pathway whereby each of the“actor concepts” in the pathway (as described herein below) is an actual or putative candidate for identifying a personality trait of an individual. The genomics information may comprise information relating to the biological interactions of each of the“concepts” in the pathway, both within the pathway as well as external to the pathway. Such external information can be used to select, de-select, or prioritize certain “steps” as trait determining targets.

### Definitions

As used in the description that follows:

“Protein” or “gene product” means a peptide, oligopeptide, polypeptide or protein, as translated or as may be modified subsequent to translation. A gene product can also be an RNA molecule.

“Biological effect” includes the molecular effects of a given biological concept as well as the effects of such concept at the level of a cell, tissue, organ system, physiology, organism, or population.

Unless otherwise specified, “include” and “includes” mean including but not limited to and “a” means one or more.

“Traits” as employed herein refers to personal characteristics, preferences, tastes, predispositions or needs that are correlated to the genetic make up of an individual (genotype) and optionally to environmental factors that, in conjunction with their genotype, correlate to the trait. Traits would include presence or absence of propensity to take risks, thrill seeking etc. Examples of traits are provided below for illustration:
reserved v warm
concrete reasoning v abstract reasoning
reactive v emotionally stable
deferential v dominant
serious v lively
expedient v rule-conscious
shy v socially bold
utilitarian v sensitive
trusting v vigilant
practical v imaginative
forthright v private
self-assured v apprehensive
traditional v open-to-change
group-oriented v self-reliant
tolerates disorder v perfectionist
relaxed v tense
Introversion-extraversion (continuum of sociability, dominance, liveliness etc)
Emotionality-stability (neuroticism) (continuum of upset and distress)

“Advertised product” may be any product that may be tailored based on a trait of an individual. Products may be a car, personal plane, boat, an investment opportunity, invitation to partake in an extreme or risky sport, outdoor activities, movies, music, travel, etc.

### The Database

A database employed in conjunction with the present invention refers to any database of information based on genomics data that correlates genes or gene products to particular personal traits.

In a preferred embodiment, information is stored in an ontology database. An ontology is a multiple-hierarchical representation of the taxonomy and formal concepts and relationships relevant to the domain of interest, preferably organized in a frame-based format. The ontology is also referred to as a knowledge representation system (“KRS”).

In the embodiment, the domain of interest is genomic information, which comprises at a minimum, information relating to genes, their DNA sequences, mRNA, the proteins that result when the genes are expressed, and one or more biological effects of the expressed proteins but which can include other, related information. It will be clear to the reader that the genomics information can also be information relating to other genomics, proteomics, metabolic and behavioral information, as well as to other biological processes and to biological components other than proteins and genes, such as cells, including, e.g., the biological effects of cells. A preferred ontology structure stores its contents in a frame-based format, which allows searching of the ontology to find relationships between or to make inferences about items stored in the ontology.

In general, the database is queried to identify pathways to a phenotypic trait, e.g., a predisposition to preference or taste or other phenotypic trait of interest, by constructing a query designed to produce a response, following computational analysis of the database (or ontology), that reveals all concepts that are biologically related to the phenotypic trait state or to a biological component of the body that is already known to be biologically related to the phenotypic trait.

The means for storing and accessing, genomics information and the means for computational analysis of complex relationships among the stored concepts will typically comprise a computer system, e.g., any type of system that comprises stored, e.g., digitized, data and a means to query the stored data. Such computer system can be a stand alone computer, a multicomponent computer, e.g., one in which the stored data are physically remote from the user interface, networked computers, etc. Any known means for querying the database will also be useful, e.g., software and hardware for electronically searching fields, categories or whole databases.

In another aspect, this invention comprises a method for targeted advertising based on a given personality trait. In this aspect, the invention comprises: (a) providing a means for storing and accessing genomics information wherein said means permits computational analysis of complex relationships among the stored concepts and (b) querying the database to identify markers that are associated with the personality trait. The markers that are associated with the personality trait are typically genetic markers, e.g., polymorphisms such as repeats, inserts, deletions, SNP's, etc. They can also be protein markers, e.g., proteins that are expressed or not expressed, relatively under expressed or over expressed, post-translationally processed differently or mutated. They can also be environmental, clinical history or behavioral markers, e.g., exposed to a particular chemical, having been treated with a particular drug regimen, or being an avid exerciser. Other markers are also useful, e.g., antibodies, mRNA, biochemical markers such as enzyme or metabolite levels, etc. The method further comprises identifying an individual having; for example, a desired genotype for a particular personality trait, and directing advertising for a product that is targeted to individuals having the same trait. It should be noted that personality is offered for illustration purposes only.

The invention encompasses any phenotypic trait. For example, the invention contemplates targeted advertising strategies based on health-oriented phenotypes. For example, targeting advertising based on a subject's predisposition to anxiety or cancer or cardiovascular disease.

The invention also encompasses strategies wherein advertising is targeted to a group of individuals sharing a common trait. For example, a method of the invention provides advertising strategies that target hair growth products to a group of users that have a hair loss genotype. This group targeting strategy is advantageous in that the group is employed as an intermediary between the data about the individual and the advertiser, providing a layer of privacy.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and systems within the scope of these claims and their equivalents be covered thereby.

1. A method for addressing targeted advertising material to a target audience comprising obtaining biological data of the target audience, correlating the biological data to a personal trait of said target audience and addressing advertising material to said target audience based on said personal trait.

2. The method of claim 1 wherein the biological information comprises information relating to one or more of a genome, individual genes, DNA sequences, mRNA, proteins and protein complexes that result when genes are expressed, drugs and metabolites they interact with, biochemical modifications, behavioral, environmental and social factors that influence the function of expressed proteins, and the biological, physiological and behavioral effects of the expressed proteins.

3. The method of claim 2 wherein the data comprise data extracted from multiple public sources.

4. The method of claim 2 wherein the data comprise data provided by users or their designated proxies.

5. The method of claim 2 wherein the data comprise data provided by health care providers.

6. The method of claim 2 wherein the data comprise data obtained directly from a biological measurement technology such as a DNA sequencer or fingerprint machine.

7. The method of claim 2 wherein the data comprises proprietary data.

8. The method of claim 1 wherein the data is extracted from an individual's medical records.

9. The method of claim 1 wherein the audience comprises at least one individual identified by an anonymous identifier.

10. The method of claim 1 wherein the target audience is an individual.

11. The method of claim 1 wherein the target audience is one more more individuals that share one or more biological types.

12. The method of claim 2 wherein the data comprises data extracted from a combination of proprietary and public data sources.

13. The method of claim 2 wherein the data comprises data extracted from a combination of proprietary and public data sources.

14. The method of claim 2 wherein the means for storing the genomics information includes an ontology in which:
(a) each gene, gene product, and biological effect is given an identifier which is related to synonyms for the identifier; and
(b) each gene, gene product, and biological effect is categorized by class.

15. The method of claim 1 wherein the trait related genomic data are prioritized based on factors that include function and complexity.

16. The method of claim 1 wherein the genomics information comprises information relating to genotype and the trait pathway comprises a gene or gene product associated with a particular genotype.

17. The method of claim 1 wherein said targeted advertising is delivered through mail, electronic media, email, internet browsing, cell phone, wireless media.

18. The method of claim 1 wherein said targeted advertising relates to a product for sport or leisure activity, investment opportunity, a car, a boat, a plane, health product or service, book or information service.
